(19) United States
(12) Patent Application Publication
(10) Pub. No.: US 2024/0044094 A1
(43) Pub. Date: Feb. 8, 2024

(54) Cyber-Physical System for Cleaning Traffic Routes and/or Outdoor Facilities

(71) Applicant: Siemens Aktiengesellschaft, München (DE)

(72) Inventor: Martin Kramer, Gauting (DE)

(73) Assignee: Siemens Aktiengesellschaft, München (DE)

(21) Appl. No.: 18/554,721

(22) PCT Filed: Apr. 13, 2022
(86) PCT No.: PCT/EP2022/059886

§ 371 Date: Oct. 10, 2023

(30) Foreign Application Priority Data
Apr. 13, 2021 (EP) 21168107.7

(51) Int. Cl. E01H 1/00; B64U 20/87

(52) U.S. Cl. CPC E01H 1/003; B64U 20/87; B64U 2101/30

(57) ABSTRACT

Various embodiments include a cyber-physical system for the automated cleaning of the edge regions of traffic routes and/or green spaces. The system may include: modules of a first type, a second type, and a third type; a communication network; and associated interfaces. The first type identifies a disturbing object. The second type receives the data from the first. The second type comprises a processor in a management system which processes the data and trains neural networks with the data using an artificial intelligence. The management system communicates with the third type and causes it to start a manipulator connected for picking up the disturbing object and/or transporting it away. Each module comprises a respective data memory and a respective processor and can start an action independently.

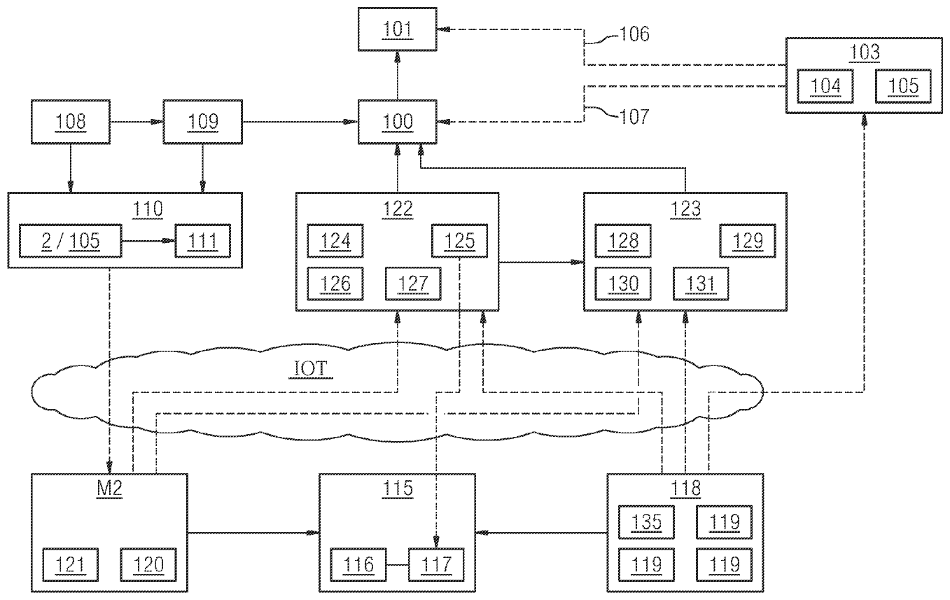

### CROSS-REFERENCE TO RELATED APPLICATIONS

This application is a U.S. National Stage Application of International Application No. PCT/EP2022/059886 filed Apr. 13, 2022, which designates the United States of America, and claims priority to EP Application No. 21168107.7 filed Apr. 13, 2021, the contents of which are hereby incorporated by reference in their entirety.

### TECHNICAL FIELD

The present disclosure relates to a cyber-physical system—CPS—for the automated detection and removal of disturbing objects in parks, outdoor facilities, roadside ditches, etc. In addition, the invention relates to a method for the automated cleaning of parks, roadsides, outdoor facilities and green spaces, in particular in town/city centers.

### BACKGROUND

The term “cyber-physical systems” denotes an interlinked grouping of sensor-based and/or mechanical modules with a data infrastructure which communicate among one another via wired or wireless communication networks, in the form of machine communication and/or using the net—Internet of Things “IoT”. For example, IT traffic control and traffic logistics systems are realized by way of cyber-physical systems. Such systems generally comprise a plurality of subsystems and are correspondingly complex.

Hitherto, road cleaning has taken place in an automated manner only on tarred roads where cleaning vehicles, controlled manually, are able to move well. Increasing urbanization and food “to go” are also accompanied by increasing contamination of green spaces and public parks by leftover food, packaging garbage and other refuse. An additional factor is dogs or other pets that may leave their mark.

### SUMMARY

There is therefore a need for automated capture and cleaning of roadsides, green spaces, and public parks. The teachings of the present disclosure are therefore based on the object of providing a cyber-physical system which removes refuse at roadsides and/or in green spaces in an automated or partly automated manner.

For example, some embodiments include a cyber-physical system for the automated cleaning of the edge regions of traffic routes and/or green spaces, comprising modules of a first and a third type, at least one communication network and associated interfaces, wherein at least a module of the first type generates data representing an actual state with a disturbing object in an automated and/or user-driven manner, optionally a module of a second type receives these data via at least one interface suitable therefor, and the at least one module of the second type comprises at least one processor in a management system which processes the data and optionally trains neural networks with the data by way of an artificial intelligence, and the management system of the second module or a direct communication of a first module with a suitable interface of a module of the third type causes the latter to start at least one manipulator which is connected to the module of the third type and is suitable for picking up the disturbing object and/or transporting it away, wherein each module comprises at least a data memory and a processor and can start an action independently, in a decentralized manner.

In some embodiments, a module of the first type (103, 110), a module of the second type (M2, 115, 118) and a module of the third type (123, 122) are realized in a single device.

In some embodiments, the device is a drone (122).

In some embodiments, the module of the second type (M2, 115) has a data archive which is communicatively connected to the machine learning system (118).

In some embodiments, a module of the second type comprises a processor in a management system (M2) which is suitable and configured for carrying out a plausibility check of the data provided by a module of the first type (103, 110).

In some embodiments, the module of the first type (103, 122, 123) comprises a 360° camera (104, 129, 125).

In some embodiments, a module of the first type (103, 122, 123, 110) is a drone (122).

In some embodiments, the modules of the first type, modules of the second type and modules of the third type are realized in a single drone (122).

In some embodiments, a module of the second type comprises a management system (M2).

In some embodiments, a module of the second type comprises a data archive (115).

In some embodiments, a module of the second type (M2) comprises a geo-information system (120).

In some embodiments, a module of the second type comprises a learning system and/or model archive (135).

As another example, some embodiments include a method for the automated cleaning of green spaces, using a cyber-physical system, wherein an actual state of a location of the green space with a disturbing object (100) is captured, wherein the capture of the data regarding a disturbing object is effected in an automated and/or user-driven manner, at least the reporting of the data generated in a user-driven manner is effected by means of transfer and provision of corresponding data optionally to a management system (M2) in a module of the second type (M2, 115, 118, 135), a module of the third type (122, 123) with a manipulator (126, 130) is activated by the management system (M2) directly or by means of at least one processor configured and designed therefor and/or by a suitable communication without interposition of the management system, and at least one module of the third type (122, 123) drives, floats and/or flies to the disturbing object, picks it up and removes it.

In some embodiments, a module of the second type (M2, 115, 118) comprises a closed-loop and open-loop control system (M2).

In some embodiments, a plausibility check (121) of the provided data from the first modules (103, 110, 122, 123) is carried out in the management system (M2) before the activation of a module of the third type (122, 123).

In some embodiments, the modules of the third type (103, 122, 123) provide data for characterizing the disturbing object (100), which they provide to the data archive (115, 116) and/or to the learning system (119) of a module of the second type for training purposes.

In some embodiments, the learning system (119) and/or model archive (135) of a second module (M2, 115, 118, 135) communicates ML models (119, 105, 131, 127) updated by training by means of an Over-the-Air “OTA” update to the modules of the first and third types (103, 110, 122, 123).

### BRIEF DESCRIPTION OF THE DRAWING

The teachings are explained in greater detail below with reference to a FIGURE, which schematically shows a system architecture of an embodiment of an example of a possible cyber-physical system incorporating teachings of the present disclosure.

### DETAILED DESCRIPTION

In some embodiments, the teachings of the present disclosure include a cyber-physical system for the automated cleaning of the edge regions of traffic routes and/or green spaces, comprising modules of a first and a third type, at least one communication network and associated interfaces, wherein at least a module of the first type generates data representing an actual state with a disturbing object in an automated and/or user-driven manner, optionally a module of a second type receives these data via at least one interface suitable therefor, and the at least one module of the second type comprises at least one processor in a management system which processes the data and optionally trains neural networks with the data by way of an artificial intelligence, and the management system of the second module or a direct communication of a first module with a suitable interface of a module of the third type causes the latter to start at least one manipulator which is connected to the module of the third type and is suitable for picking up the disturbing object and/or transporting it away, wherein each module comprises at least a data memory and a processor and can start an action independently, in a decentralized manner.

As another example, some embodiments include a method for the automated cleaning of green spaces, using a cyber-physical system as described above, wherein an actual state of a location of the green space with a disturbing object is captured, wherein the capture of the data regarding a disturbing object is effected in an automated and/or user-driven manner, at least the reporting of the data generated in a user-driven manner is effected by means of transfer and provision of corresponding data optionally to a management system in a module of the second type, a module of the third type with a manipulator is activated by the management system directly or by means of at least one processor configured and designed therefor and/or by suitable communication without interposition of the management system, and at least one module of the third type drives, floats and/or flies to the disturbing object, picks it up and/or removes it.

Various embodiments of the present disclosure use a communicating combination of modules which combines in particular modules of a first type, which are devices for capturing, imaging, locating and forwarding of the corresponding data, modules of a second type, which are devices for processing, for open-loop control, for closed-loop control, for machine learning and/or for comparison of data, and modules of a third type, which are devices with manipulators for grasping, sucking up and/or transporting objects, for example in such a way that a navigation system is concomitantly connected and in particular with the aid of artificial intelligence a constantly improving and self-enhancing cyber-physical system which, either by way of users of smartphones who are moving in parks or outdoor facilities, from the cyber-physical system's own operating data and/or by way of stationary or mobile surveillance systems which scan outdoor facilities and/or parks, detect disturbing objects there; with the collected data from these sources, the cyber-physical system is trainable and can remove disturbing objects in an automated manner. For this purpose, the cyber-physical system comprises modules of the third type with manipulators which, after received reporting by means of one or more modules of the first type regarding at least one disturbing object—optionally by means of a management system as part of a module of the second type—wherein the modules of the third type are optionally selected with feedback with IoT and/or AI, the latter are activated and guided to the place where the disturbing object was found.

These modules of the third type can comprise a plurality of individual devices which—optionally in collaboration—drive, float and/or fly to the at least one disturbing object, pick it up and/or transport it away in an automated manner under remote control. In this case, the reporting regarding the disturbing object is effected either manually by a user by means of a smartphone app or in an automated manner by way of correspondingly trained detection systems which are suitable and/or trained for differentiating disturbing objects from non-disturbing objects in the corresponding outdoor facility or in outdoor facilities generally, such as areas of grass.

“Machine communication” denotes an automated exchange of information between devices such as machines, drones, automatic apparatuses, vehicles, containers and/or with a—preferably central—management system, for example via Bluetooth, Wi-Fi, optically, by means of ultrasound, sound waves and/or radio waves, for example by means of wireless communication with low power consumption such as LoRa, LoRaWAN, IrDA, ZigBee, XBee and/or infrasound.

Machine communication can take place from machine to machine, but also via the Internet of Things, IoT, via mobile radio networks, or other networks. The technology of machine communication here combines information technology and communication technology.

“ZigBee” and/or “XBee” are communication tools specifically for wireless networks and low data traffic; they also communicate for example in a mesh network and/or a so-called ad hoc network.

“LoRaWAN” has a network architecture which is typically arranged in a star topology, wherein the gateways establish the connection between the terminals and the central network server. The gateways are connected to the corresponding network server via a standard IP connection, while the terminals use a single-hop connection to one or more gateways. The communication is generally bidirectional. It also supports the operation of multicast address groups in order to ensure efficient use of the spectrum for e.g. Over-the-Air updates (“OTA” updates).

LoRaWAN is a Low Power Wide Area Network (LPWAN) specification for wireless battery-operated systems in a regional, national or global network. It is also aimed in particular at secure bidirectional communication, localization and mobility of services, end-to-end encryption and mobility of services. The LoRaWAN specification offers seamless cooperation of different subsystems and technologies among smart things without the need for rigid, local complex installations. “LoRa” here describes the physical layer that enables the “long range” communication connection.

In the present disclosure, “edge region”, “green space”, “outdoor facility”, “park” denotes a region which can be contaminated by all kinds of disturbing objects left behind and discarded. It is unimportant whether this region is otherwise maintained or cleaned by gardeners, forest rangers or other managers, rather—at least as long as the cyber-physical system of the park facility has not yet been in operation long enough to be able to take a decision autonomously—the intention is for the user of the green space to establish whether or not an object left behind there is found to be “disturbing”. “Disturbing” in the simplest case is for example dog excrement, fast food packaging left behind, leftover food, empty, full or partially filled glass packaging, other garbage, plastic, cloth and/or paper bags, in short everything that the user would prefer to see in a trash can, but sees lying around on dirt tracks, areas of grass, in forests and/or in hedges and bushes.

In the present disclosure, “target state” denotes the state of the green space and edge region in which the disturbing object is gone, in particular has been removed, and the—to the user uncontaminated, desired and/or natural state of the edge region and/or park and/or outdoor facility and/or green space has been established.

By means of the corresponding communication infrastructure—optionally with the inclusion of the IoT and an artificial intelligence—the cyber-physical system is set up such that it is usable for cleaning green spaces in an automated manner.

A module of the second type comprises a processor and for example at least one further processor which communicates with the first processor and is suitable for carrying out training for the purpose of automated recognition of disturbing objects by way of data generated in a user-driven manner. Furthermore, the processor of a module of the second type may be communicatively connected to a data archive, wherein firstly the data of the modules of the first type, the estimated values and assumptions regarding the physical and/or chemical constitution of the disturbing object, and secondly, after corresponding feedback or return transmission, the data collected from the disturbing object by concrete measurement and/or characterization of a module of the third type are storable in the data archive. The module of the second type is also the one which trains the neural networks and provides them—e.g. in the form of updates—to the modules of the first and third types. An additional processor of such a module can be of the TPU and/or GPU type, for example.

As a result, the data of the actual state that are provided by way of the reporting or provision of the data by one or more modules of the first type, can be compared with the data that are provided by the module(s) of the third type regarding the “truth” for the data from the actual measurement and/or characterization results of the same disturbing object. By comparing these data, the cyber-physical system can learn much about the capture of the disturbing objects in an automated manner. In some embodiments, a learning system, for example in the form of an artificial intelligence—“AI”—is provided in the module of the second type.

All data of the system, not just those from the data archive, can be used for the training of the cyber-physical system, and so the cyber-physical system continuously improves. The machine learning processor(s) of the modules of the second type make available their most recent ML models, for example in the form of updates, in some cases automatically, to the modules of the first and/or third type.

In some embodiments, the data collection is effected at least initially in part by human beings, so-called “data generated in a user-driven manner for the capture of disturbing objects”, human beings who as “users” of the park deliberately photograph refuse there and thus make available to the artificial intelligence visual or optical or—depending on the capturing pick-up device—other data from refuse which by machine were perhaps not classified as “disturbing object”, but by means of data classified by the user serve as a basis of suitable training of the neural network belonging to the AI in a module of the second type. After a training phase, these trained neural networks can be transferred back to the modules of the first and third types and then have the effect that by means of the modules of the first and third types, in an automated manner, such disturbing objects are classified and become recognizable as “disturbing object” independently by means of the cyber-physical system. The data collection by users during initial operation may be used to refine the pretrained generic neural networks more specifically to the area of application.

By means of putting the cyber-physical system into operation and generating data—by machine and/or in a user-driven manner—a neural network of an AI which is connected to the module of the second type is trained. The trained network is then “deployed”, e.g. transferred and stored, in a drone, which can comprise both a module of the first type for capture and a module of the third type for clearing away.

Afterward, the drone thus equipped, the self-driving robot thus equipped, is itself capable of automatically classifying refuse as such within the area for which it is trained, on the basis of the artificially collected data and/or the data collected by human beings and/or the training carried out. For example, the drone then develops the network further by way of as many training data as desired and/or obtains updates from the module of the second type, which generally comprises a more powerful, in particular generic, processor than the modules of the first and third types which are accommodated in a drone, for example, which processor trains neural networks and can then transfer the trained networks back again to a module of the third type, such as the drone.

If a correspondingly equipped drone provided with a correspondingly trained network, or some other pick-up device with camera, recognizes and classifies refuse in an automated manner by way of its module of the first type, it can pick up and remove the refuse by way of a module of the third type which is likewise realized in the drone, such as a suitable manipulator, e.g. gripping arm, without a detour via a central management system realized in particular in a module of the second type. For this reason, the cyber-physical system disclosed here can also be referred to as a system “that reacts in a decentralized manner” because after a corresponding training phase of the individual modules, the latter are enabled to carry out cleaning work in an automated and self-controlling manner without a central management system.

For the training of the neural network of the artificial intelligence AI integrated in the cyber-physical system, it is possible, as stated, to use the data generated in a user-driven manner and/or the data generated in an automated manner.

For example, once the refuse has been identified, prior to removal, a module of the third type can optically capture said refuse even further and generate further visual data in respect thereof, in particular with different illumination and/or from a different viewing angle, for example. The data thus generated can then be used for training purposes again in the system. In this regard, the system can be further trained and improved and/or updated by each further work operation.

From the beginning, the cyber-physical system is usable even without human beings, but the human being—or the user—is instrumentalized by means of a cellphone. In order to prevent enormous amounts of unnecessary or unusable data from inundating the cyber-physical system, the smartphone has a collecting point, for example, which effects presorting according to “plausibility” by way of an app.

In this case, new data are compared with data which are usable and correct and data which are unusable and incorrect; both correct data and the incorrect data can be identified by human beings or by machine. For example, a “false positive recognition” can be provided by means of comparisons in the system.

A “learning system” is used to mean an artificial intelligence which is trainable by means of data such as the results of comparisons, for example.

During operation, all images are uploaded into the data storage system and, from this data storage system, one or more neural networks are trained which are then available as AI to the cyber-physical system and can be distributed among the individual modules having platforms on which the neural networks can run. In some embodiments, the data storage system feeds one or more neural networks which have the same function but run on different platforms. The individual modules are part of devices which are connected via radio and/or in a wired manner, for example.

An execution platform could be for example on a mobile device and/or part of a robot, of a drone, and/or in a drone a sensor, part of a sensor, and/or some other function that is comprised in a camera and is to be trained, for example.

Such a function can be segmentation in an image, for example. The system recognizes something and emphasizes it. The “cutting out” results in simplifying the classification of what was cut out.

In some embodiments, the data storage system serves as a database for the training of a neural network. Machine-based and/or user-driven, human-based, object recognition serves in particular as a precursor for segmentation within the cyber-physical system.

In some embodiments, the AI and/or the data storage system are/is used to create so-called “heat maps” within the area covered by the cyber-physical system. The heat maps reproduce the area on a map in which regions are identified according to the frequency of finding disturbing objects and/or refuse there. By way of the AI, it is thus possible to identify locations where a large amount of garbage has already been found, and the cyber-physical system learns to intensify the search there. In this case, an enormous increase in the efficiency of the cyber-physical system can occur because regions in which garbage is never found are captured only to a slight extent, whereas the neuralgic points are subjected to intensified monitoring. In this case, once again the cyber-physical system constantly undergoes further development and can thus make updates available to the individual modules, in regard to regions where e.g. 95% of the garbage has hitherto been found.

In some embodiments, the following modules of the first type which serve for picking up and reporting and/or detecting a disturbing object are used:

Surveillance cameras, stationary and/or mobile, and/or users with smartphones who, with a correspondingly programmed app, detect disturbing objects—in some cases, segment and classify and report them in an automated manner—e.g. by way of the camera function refuse in park facilities. In this case, the surveillance system and/or the smartphone generate(s) by means of an app—which for example is connected to an artificial intelligence such that it obtains updates—sensor system and/or camera data that are automatically provided to a module of the second type. The modules of the first type may be equipped in particular such that they report the kind of disturbing object in a classified manner, i.e. e.g. biowaste, glass waste, plastic waste, lost property, etc.; for this purpose, the modules of the first type comprise for example sensors and/or processors with stored visual comparison data that compare whether the surface of the detected disturbing object is solid, soft, lustrous, matt, porous, liquid, dispersive, e.g. solid constituents in a liquid, muddy, etc. Further modules of the first type with detectors could pick up and compare odors, for example.

In some embodiments, a report classified in this way regarding the disturbing object is forwarded by a module of the first type via the corresponding communication interface, e.g. with locating data, to a module of the second type, which may firstly check these data for plausibility.

The plausibility can include a number of factors; by way of example, the plausibility can firstly serve to establish whether the disturbing object reported can actually be there.

A report checked for plausibility is then forwarded to a closed-loop and open-loop control system, which activates at least one corresponding unit pertaining to drive technology in the form of a module of the third type, a device which can move under remote control and drives to predefined coordinates in an automated manner and which furthermore has manipulators as picking up means, such as, for example, a suction unit, a gripping arm, etc., by way of which the device can pick up and/or transport a disturbing object.

A module of the first type can be for example a mobile surveillance camera as part of a drone equipped with a camera. A module of the third type can be for example a drone having one or more gripping arms. In some embodiments, for example, both modules, those of the first and third types, can be realized in the same drone. In this case, the drone has for example firstly a camera, secondly a gripping arm and in addition a data infrastructure and interfaces via which the data of the camera are provided to the gripping arm via a suitable interface.

In some embodiments, data infrastructure, communication means and interfaces, just like camera and gripping arm, can be realized in a drone, and so physically everything required for providing such an embodiment of the cyber-physical system according to the invention is realized in one drone.

The term “drone” denotes an unmanned vehicle, in particular aircraft, which can be operated and navigated autonomously by a computer by way of remote control, without a crew on board. A drone can also be for example an unmanned cargo vehicle and/or a boat or an amphibious vehicle. A “drone” can also comprise a manipulator, such as a gripping arm and/or a suction device, for example. A drone within the meaning of the present invention can have everything realized in one device, for example from reporting through control and finally also the transaction by means of a manipulator.

The module of the second type comprises in particular a management system which has or is connected to a geo-information system (GIS). The module of the second type can be realized for example in the form of a processor that is part of a data processing unit of a remote-controllable drone.

In some embodiments, the module of the second type comprises one or more processor(s) designed to carry out a check of the report by the module of the first type for plausibility in a computer-aided manner.

The term “management system” denotes, in principle, any type of controller which receives from a module of the first type and carries out processing and also controls a module of the third type by open-loop and/or closed-loop control. The management system as at least part of the module of the second type can be—from a physical standpoint—part of a module of the first and/or third type. In particular, any type of the modules, interfaces and communication systems according to the present invention can be realized in—for example—a drone, a remote-controlled vehicle. In this case, communication with the IoT, exactly as in the case of a smartphone, may or may not be realized.

The term “IoT” denotes the Internet of Things, a collective term for technologies of a global infrastructure of information societies which makes it possible to network physical and virtual objects together and to allow them to cooperate by means of information and communication technologies. In the IoT, a geo-information system is incorporated, for example, which enables the capture, processing, organization, and presentation of spatial data, in particular also locating of a disturbing object reported.

A “module” means for example a drone, a remote-controlled vehicle, a robot, an automatic apparatus, a camera, a sensor, a processor and/or a storage unit for storing program code. By way of example, the processor is specifically designed to execute the program code so that the processor executes functions in order to implement or realize one or more of the methods described herein or a element of such a method. The respective modules can also be embodied as separate or independent modules, for example. For this purpose, the corresponding modules can comprise further elements, for example.

These elements are for example one or more interfaces (e.g. memory interfaces, database interfaces, communication interfaces—e.g. network interface, WLAN interface) and/or an evaluation unit (e.g. a processor) and/or a storage unit, such as a data storage system, which is usable as a basis for training neural networks and/or an artificial intelligence AI. By means of the interfaces, for example, data can be exchanged (e.g. received, communicated, transmitted or provided). By means of the evaluation unit, for example, in a computer-aided and/or automated manner, data can be generated, compared, checked, processed, assigned or calculated. By means of the storage unit, for example, in a computer-aided and/or automated manner, data can be stored, retrieved or provided.

A module of the first type is any type of sensor device and/or pick-up device which recognizes and reports a disturbing object, picks up the “actual state” and generates therefrom data that are processable in a computer-aided manner. By way of example, a module of the first type can generate visual data by way of a camera function, or pick up and analyze odors by way of a sensor function, which are then transmitted and/or communicated to a module of the third type via a module of the second type.

One type of “module of the first type” is a smartphone of a visitor to the park facility, who has preferably installed an app that is connected to the cyber-physical system and enables the visitor to feed “user-driven” data to the system. This visitor then photographs the garbage or refuse that he/she has discovered, e.g. by way of the app, and the app carries out a plausibility check and sends these visual, optical and/or other data generated in a user-driven manner to the cyber-physical system, or a data storage system thereof. For data capture without an app on the part of a park facility visitor, some other connection to a data storage system of the cyber-physical system could alternatively be established.

In some embodiments, the module of the first type, together with the reproduction of the actual state, i.e. e.g. the representation of the disturbing object and the associated spatial coordinates, a classification and/or a segmentation of the disturbing object is also performed, for example in respect of the kind of biowaste, leftover food, packaging remains, paper, glass, etc., which is likewise communicated to the module of the second type, together with the report.

In some embodiments, the report is accompanied by so-called “intelligent fuzziness”, such that the module of the first type firstly recognizes, captures and reports a disturbing object, but at the same time is not prevented from recognizing, capturing and reporting further disturbing objects in the immediate vicinity, for example. Intelligent fuzziness, also known as “fuzzy search”, comprises e.g. a search method in which not only the exact character sequence but also similar character strings are found. This technique can also be applied to finding disturbing objects in outdoor facilities.

In some embodiments, a cyber-physical system configured and designed with intelligent fuzziness recognizes packaging alongside leftover food, and or else a scattered, diffuse, contamination by confetti, etc., and does not fly to the trash can after each piece of confetti collected and unload the latter, but rather collects the pieces of confetti in a region and removes a significant amount of confetti all at once.

In some embodiments, without dedicated reporting, immediately upon recognition of the disturbing object, can set up communication with the module of the third type, which then activates the module of the third type and carries out the removal without further checking and/or without further instructions. In the case of such a set-up, the “module of the second type” in the cyber-physical system is for example one or more suitable interface(s) and/or the communication between the module of the first type and the module of the third type. The module of the second type receives the data of the module of the first type via a suitable interface and either passes them directly to a module of the third type or processes them in the management system.

Particularly if the modules of the first, second, and third types are not just realized in a single device, such as a single drone, they are in particular a module or a part of a module of the second type which is connected to the IoT and/or to an AI. The module of the second type calculates—e.g. via an interface and communication with the IoT and/or AI, respectively—a plausibility; for example, is it possible for there to be dog excrement in the middle of the river?—before the further processing of the data takes place.

Owing to the data archive, too, a connection to the IoT is preferably provided in the module of the second type. This is so particularly because even in the case of a deployment of a module of the first, second and third types in a drone, that is for example a mini-deployment of a module of the second type, in the sense of a temporary representative (proxy) in offline scenarios.

By way of example, although the drone would collect training data offline, e.g. without a connection to the IoT, during operation, the training itself is cloud-based, i.e. requires a connection to the IoT.

In the module of the second type, e.g. the data of the module(s) of the first type that have been checked for plausibility are compared with data of a database present there in a computer-aided manner. In this regard, for example, garbage, refuse, leftover food and/or dog excrement which is captured by a camera can be identified and located by means of the IoT or some other data infrastructure comprising a navigation system.

The module of the second type which is connected to the IoT carries out e.g. the following processes:
locating the refuse captured by way of a module of the first type,
checking the plausibility of the identified refuse with the locating,
selecting—optionally by means of an AI and/or other machine learning—from the known data concerning refuse, garbage, feces, etc., a type of the module(s) of the third type, i.e. a type of the transporting away, e.g. drone, suction, sweeping and/or wiping robot, and/or combinations thereof,
activating the module of the third type for removing and/or for transporting away, in particular by means of an integrated or connected open-loop and closed-loop control system,
controlling and/or guiding the module of the third type to the location where the disturbing object was located, controlling, by closed-loop and open-loop control, the transporting away of the garbage by one or more module(s) of the third type, and
receiving and processing feedback of the module of the third type regarding the physical and/or chemical characterization of the disturbing object and/or the success of the transporting away as training data for an artificial intelligence which is attached and/or connected to the module of the second type.

The module of the second type triggers a command and/or a controller which activates at least one module of the third type, for example a robot and/or a drone, controls same to the location and there removes, for example sucks up or picks up, the disturbing object, e.g. the dog excrement and/or the refuse, by way of corresponding drives and tools on the module of the third type. The controller then guides this module of the third type together with the load to a station for disposal, for example a trash can or the like.

In some embodiments, the station for disposal is mobile, for example a driving truck, optionally also remote-controlled truck, in particular also a truck remote-controlled in an automated manner, which receives the refuse and drives it to the garbage can or to a garbage further-processing facility, such as a recycling station or the like, depending on the type and constitution of the disturbing object.

In some embodiments, a module of the third type comprises a manipulator with a drive and for example a gripping arm, a suction unit or a mop. By way of example, a module of the third type is a drone or a suction robot that deliberately picks up the “reported” garbage and takes it to the station for disposal, for example to a truck, repository or a garbage container.

In some embodiments, the module of the third type transfers the result of removal back to the module of the second type via an interface, such that the module of the second type has feedback as to whether the solution found, e.g. the removal of the garbage by means of the activated actuator, was successful, not very successful or not successful at all. It is likewise optionally provided that the module of the third type that knows “the truth” measures, weighs, physically and/or chemically analyzes the disturbing object and can thus provide the module of the second type with data with which it can compare the data that originate from the capture of the disturbing object by way of visual or other pick-up by a module of the first type. These data can be stored in the data archive and can be made available there to an artificial intelligence.

In some embodiments, the module of the second type comprises such a processor which comprises an AI in order to learn from the results of the respective actions of the modules of the third type in an automated manner, for example, which manipulator is appropriate for which refuse at which location. These ML models which arise from the automatic learning are then made available in turn to all the other modules in the cyber-physical system. The FIGURE depicts the disturbing object, comprising garbage or lost property 100, which is found and reported in the park 101 by way of a module of the first type 103, 110, such as a stationary and/or mobile surveillance system 103, e.g. a closed circuit television CCTV system 103 and/or a drone having a camera 104 and optionally a computer-aided machine learning model ML model system 105. The stationary surveillance system monitors—represented by way of arrow 106—the park 101 and finds—see arrow 107—the disturbing object 100. By means of the automatic reporting system integrated in the CCTV system, the CCTV system shown here, courtesy of its ML model 105, optionally with the aid of corresponding sensors (not shown), reports, segments and classifies the disturbing object according to the type of constitution, or the type of lost property, at least according to dimensions, surface constitution, size, weight, etc. The classification and segmentation will proceed better or worse depending on the level of maturity of the machine learning ML model 105 integrated here.

In some embodiments, the system illustrated here is continuously improved during use by way of the feedback 105, 127, 130 with artificial intelligence 118, which constantly trains the performed classification and/or segmentation by way of data 115, 116, 117 captured and classified by means of the camera 104 in the CCTV 103. These metadata 116 concerning the disturbing object, just like the data 117 with which the disturbing object was captured, for example the visual data from the camera, are transmitted to a management system M2.

Secondly, for example, a user 108 with their smartphone 109 is strolling through the park and, using a corresponding app 109, photographs—see arrow 1—the disturbing object 100 using the smartphone 109. From the photograph 111, the app generates metadata 2 such as classification, size, assumed weight and the instruction 110 and is suitable for segmenting, locating, and describing the disturbing object 100. For this purpose, the app 110 optionally has corresponding sensors and/or comparison data. Secondly, by way of the app, the user can also input their categorization and their metadata 2 concerning the photograph 111 or the disturbing object 100, such that these are likewise forwarded—e.g. via the IoT—to a management system M2 of the connected module of the second type M2, 115, 118.

The module(s) of the first type 103, 110 provide the visual data of the capture of the disturbing object 100, just like metadata 2 that are possibly available, to one or more module(s) of the second type; for example, the data are provided to the management system M2 having a geo-information system (GIS) and also planning and supervisory capabilities. There, the visual, acoustic and other data which are part of the instruction are processed; in particular, they are checked for plausibility and relevance—e.g. is it possible for there to be dog excrement in the middle of a pond or is the disturbing object situated in a region that is not envisaged for cleaning?

The use of the cyber-physical system can easily be ascertained by data and the recordings of disturbing objects together with a spatial indication being sent to a corresponding communication interface, wherein the interface traces the reception of these data back to the transmitter and thus checks the authorization of the transmitter and/or of the transmitting device.

In the management system (open-loop and/or closed-loop control system) M2, depending on the type of disturbing object 100 and depending on the location where the latter is situated, the modules of the third type, such as drone, robot, for example suction and/or sweeping robot, cargo vehicle, floating load-pick-up apparatus and/or transporter, are activated and instructed to pick up the disturbing object and/or to transport it away.

Criteria for the selection of the module of the third type by the management system are for example:
competence for the place of finding
competence for the type of disturbing object
reachability for the chosen device (land/water/air)
range—stationed close enough to the location
enough loading capacity for the disturbing object
can the module of the third type load/collect the disturbing object, e.g. depending on the gripping strategy, mechanical loading capacity of the module of the third type and/or depending on the carrying capacity
possibility of the module of the third type being able to drive, float and/or fly to the location by way of remote control, optionally automated remote control.

For example, the module of the third type can be a flying, driving and/or floating drone which is optionally coupled to one or more further drones with which it automatically coordinates itself and optionally offloads the load, the disturbing object 100, and/or shares the burden.

The module of the second type, e.g. the management system M2, is activated by the module(s) of the first type in an automated manner by way of the provision and the reception of the data. The data firstly are stored within the module of the second type in a data archive 115, for example in association with the “instruction 1 . . . n” 116 and/or the “actual image” 117, and secondly they are used to enable the artificial intelligence “AI” 118, the machine learning system, for example, for the training of the “ML” models 119 of an optionally integrated and/or connected AI and/or model archive 118.

A module of the second type such as—in the embodiment illustrated in the FIGURE—the management system M2 having a smart control system, for example, comprises at least one processor configured such that from the received data together with the data which it can access, such as, for example, the data from the data archive 115 and/or the results from the AI 118, said processor works out a relevance of the instruction after the checking for plausibility. The relevance is present for example in the form of a prioritization of the order in which the instructions are to be processed.

The AI 118 feeds a model archive 135 and/or “AI” and/or artificial intelligence with constantly improved ML models 119. The training is triggered by retrieval of the data from the data archive 115. Firstly the data of the modules of the first type 117, which represent the “actual state”, and secondly the data 116 collected by way of the characterization by the modules of the third type are made available in the data archive 115.

The term “AI” denotes the automation of intelligent behavior and machine learning. Artificial intelligence attempts to emulate certain decision structures of human beings by means of statistical methods and/or neural networks that are modeled in some way on brain structures. For this purpose, e.g. according to an “iterative method”, a decision is repeatedly taken by the system in an automated manner and implemented and the result is evaluated; if the decision and subsequently the result were helpful, the path is taken for further decisions, and if not, this path is classified as the “wrong track” and avoided for future decisions.

Typical ways of training an AI are:
a) supervised learning by comparing the feedback of the learning module with the data actually present, and
b) by way of data collection in a data archive, where the training effect is that over time more and more data are present with which the module can compare its data that it receives.

In the disclosure, a “processor” can be understood to mean for example a machine or an electronic circuit. A processor can be in particular a central processing unit (CPU), a microprocessor or a microcontroller, a TPU (tensor processor unit) and/or NPU (neural processing unit), which are technically similar to a hybrid of ASIC and FPGA and/or DSP. In addition, there are COTS boards, e.g. Google Coral or Intel Movidius which are also designated as VPUs, AI coprocessors. For example, it can also be an application-specific integrated circuit or a digital signal processor, possibly in combination with a storage unit for storing program instructions, etc. A processor can for example also be an IC (integrated circuit), in particular an FPGA (field programmable gate array) or an ASIC (application-specific integrated circuit), or a DSP (digital signal processor) or a graphic processing unit (GPU). Moreover, a processor can be understood to mean a virtualized processor, a virtual machine or a soft CPU. It can also be a programmable processor, for example, which is equipped with configuration steps for carrying out the stated method according to the invention or is configured with configuration steps in such a way that the programmable processor realizes the features according to the methods or of the modules, or of other aspects and/or partial aspects of the disclosure.

The processors that are usable in the system are at least application processors, for example Cortex A, in terms of the performance classes. In the module of the second type, the management system within the cyber-physical system, processors from higher performance classes may be used, for example those whose number of available cores is between one and eight. The number of cores in a processor indicates how many things the processor can do in parallel and/or the clock frequency. For example, CPU/TPU/GPU are used as a generic processor.

Microprocessors, in contrast to microcontrollers, e.g. K60, are not expediently usable here because neural networks cannot be expediently run on them. “Computer-aided” means for example an implementation of the method in which in particular a processor carries out at least one method step of the method. By way of example, “computer-aided” should also be understood to mean “computer-implemented”.

“Providing”, in particular with regard to data, metadata and/or other information, can be understood to mean for example computer-aided providing. Providing takes place for example via an interface (e.g. a database interface, a network interface, an interface to a storage unit). Via this interface, for example, corresponding data and/or information can be communicated and/or transmitted and/or retrieved and/or received during providing. In association with the invention, “providing” can for example also be understood to mean loading or storing, for example of a transaction with corresponding data. “Providing” can for example also be understood to mean transferring (or transmitting or communicating) corresponding data from one node to another node.

In the management system M2, optionally by way of the AI, a recovery strategy for the disturbing object 100 is worked out and at least one module of the third type 122 and/or 123—a tool for transporting away, e.g. drone, cargo vehicle, suction, sweeping and/or wiping robot, and optionally combinations thereof, in a demand-oriented manner—i.e. for example depending on the classification of the disturbing object 100—is instructed.

The modules of the third type 122, 123 are networked with the management system M2 and with one another and can communicate with one another in an automated manner directly and/or via the IoT and/or via the management system M2. In the embodiment shown here, the module of the third type 122 is a remote-controllable drone 122 having a position-determining unit 124, for example GPS, a camera 125, for example a 360° camera 125, an AI with a machine learning “ML” model 127, and finally a manipulator, such as a gripping arm 126.

In the example shown in the FIGURE, the module of the third type 123 is a remote-controllable cargo vehicle 123, likewise having a position-determining unit 128, a camera 129, an AI with a machine learning “ML” model 131, and a manipulator, such as a gripping arm 130. The module 122, 123 is controllable in an automated manner, just like the manipulators 130 and 126.

The instructed modules of the third type 122 and 123 mutually coordinate themselves, meet together at the site of use and recover and transport the disturbing object 100. In this process, the disturbing object 100 is localized, photographed, and recovered. By way of example, the modules 122 and/or 123 also have means for characterizing, for example for weighing and/or measuring, the disturbing object 100. These data are provided for the training of the machine learning system 118 and/or to the data archive 115 of a module of the second type. The provided data 116 from the real measurement by the modules of the third type can then be provided to the machine learning systems 118 and/or the model archive 135 of a module of the second type. The gathered information and data 117, 116 of the physical and/or chemical characterization of the disturbing object 100 are also provided to the module of the second type, for example in the data archive 115, as data 116 accessed by the machine learning system 118. This is also the case for example in regard to a comparison with the data 117 of the actual state from the assumed and/or estimated data of the modules of the first type 103, 110.

If a cargo vehicle 123 having a greater loading capacity than needed by the disturbing object 100 is situated at the site of use, further disturbing objects (not illustrated) or else other items are loaded onto this, without the cargo vehicle 123 driving back to the station beforehand. The communication among the modules is geared toward always finding the simplest solution. The modules of the third type 122, which are also appropriate for the cargo vehicle 123 for example in terms of weight/size, can also be returned to a base station by said vehicle.

In some embodiments, the modules of the third type 122, 123 provide data for characterizing the disturbing object 100, which they provide to the data archive 115, 116 and/or to the machine learning system 118 of a module of the second type for training purposes. By means of the capture of the approximately estimated instruction data regarding the physical dimensions of the disturbing object, the plausibility check 121 in the smart management system M2, and the storage in the data archive 115, 117 and also the comparison with reality by way of the captured data 116 from the weighing and measuring during collection by the modules of the third type 122 and/or 123, the cyber-physical system captures training data in order to sensitize its own machine learning ML models 119, 105, 127 and 131 by training and to increase their accuracy during operation.

The ML models 119 that are updated in the module of the second type 118 are communicated “into the field” and are introduced for example by way of an “Over-the-Air” OTA update into the modules of the third type 122 and/or 123, where they are present in the form of the ML models 127 and/or 131.

The ML models 119 are not digital copies of one another, rather they are always the result of the respective machine learning process which takes place in the machine learning system 118 and/or is available in stored fashion in the model archive 118, wherein the machine learning system makes use of the data from the data archive 115, for example, and the result in the form of the respective ML model 119 is provided in tailored fashion to the models of the first type and respectively the third type. In some embodiments, these ML models 119 are also stored again in the model archive 135. In this regard, transfer learning is possible as well.

As a result, the cyber-physical system—in particular one in a park in which the system has already been trained—over time automatically becomes acquainted with all types of disturbing objects 100 that arise, and can recognize, report and eliminate contaminations in an automated manner by way of the modules 103, 122 and 123 in the monitoring mode.

However, for users, too, who report to the cyber-physical system using smartphone or app, the enhanced capabilities, e.g. also in the form of ML models, can be introduced by way of OTA updates into the apps. In this case, it is entirely possible for a single drone 122, as well as a camera 125 situated therein or thereon, to be used both as a module of the first type for detecting and reporting a disturbing object and as a module of the third type for collecting and transporting through the cyber-physical system.

By virtue of the autonomous improvement of the cyber-physical system during use, the present disclosure makes available for the first time a possibility for the automated cleaning of green areas, outdoor facilities and all parks.

The disclosure relates to a cyber-physical system—CPS— for the automated detection and removal of disturbing objects in parks, outdoor facilities, roadside ditches, etc. In addition, the invention relates to a method for the automated cleaning of parks, roadsides, outdoor facilities and green spaces, in particular in town/city centers. In this case, modules of first, second and third types are communicatively connected via the IoT in such a way that modules of the first type pick up the actual state and provide the data generated therefrom to the modules of the second type via the IoT, and the modules of the second type then calculate a target state and activate modules of the third type, optionally via the IoT, in order to establish the target state. The modules of the third type, having manipulators, e.g. a gripping arm, a suction unit, generally a picking-up device, etc., collect the disturbing object, and can optionally characterize it and provide the data of the characterization to the ML models of the modules of the second type for training purposes before these modules of the third type transport the disturbing object away. In particular by virtue of the availability of the actual characterization of the disturbing object and the possibility of comparison with the estimated data of the modules of the first type, the cyber-physical system can constantly improve itself and specialize in the green space that is the focus of attention.

What is claimed is:

1. A cyber-physical system for the automated cleaning of the edge regions of traffic routes and/or green spaces, the system comprising:
modules of a first type, a second type, and a third type;
a communication network; and
associated interfaces;
wherein
a module of the first type generates data representing an actual state with a disturbing object;
a module of a second type receives the data via an interface;
the module of the second type comprises a processor in a management system which processes the data and trains neural networks with the data using an artificial intelligence; and
the management system of the second module communicates with a module of the third type and causes the module of the third type to start a manipulator connected to the module of the third type for picking up the disturbing object and/or transporting it away; and
each module comprises a respective data memory and a respective processor and can start an action independently.

2. The cyber-physical system as claimed in claim 1, wherein a single device comprises the module of the first type, the module of the second type, and the module of the third type.

3. The cyber-physical system as claimed in claim 2, wherein the device comprises a drone.

4. The cyber-physical system as claimed in claim 1, wherein the module of the second type includes a data archive communicatively connected to the machine learning system.

5. The cyber-physical system as claimed in claim 1, wherein the module of the second type comprises a processor in a management system configured for carrying out a plausibility check of the data provided by the module of the first type.

6. The cyber-physical system as claimed in claim 1, wherein the module of the first type comprises a 360° camera.

7. The cyber-physical system as claimed in claim 1, wherein the module of the first type comprises a drone.

8. The cyber-physical system as claimed in claim 1, wherein a single drone comprises the module of the first type, the module of the second type, and the module of the third type.

9. The cyber-physical system as claimed in claim 1, wherein the module of the second type comprises a management system.

10. The cyber-physical system as claimed in claim 1, wherein the module of the second type comprises a data archive.

11. The cyber-physical system as claimed in claim 1, wherein the module of the second type comprises a geo-information system.

12. The cyber-physical system as claimed in claim 1, wherein the module of the second type comprises a learning system and/or a model archive.

13. A method for the automated cleaning of green spaces using a cyber-physical system, the method comprising:
capturing an actual state of a location of the green space with a disturbing object in an automated and/or user-driven manner;
reporting the data generated by transferring corresponding data to a management system in a second module;
activating a module of a third type with a manipulator by the management system; and
removing the disturbing object with the module of the third type which drives, floats and/or flies to the disturbing object, picks it up, and removes it.

14. The method as claimed in claim 13, wherein the module of the second type comprises a closed-loop and open-loop control system.

15. The method as claimed in claim 13, further comprising carrying out a plausibility check of the provided data from the first module in the management system before activating the module of the third type.

16. The method as claimed in claim 13, wherein the module of the third type provides data for characterizing the disturbing object to the data archive and/or to the learning system of the module of the second type for training purposes.

17. The method as claimed in claim 16, wherein the learning system and/or model archive of the second module communicates ML models updated by training by an Over-the-Air “OTA” update to the modules of the first type and the third type.
